(19) United States
(12) Patent Application Publication
(10) Pub. No.: US 2025/0312739 A1
(43) Pub. Date: Oct. 9, 2025

(54) EXHAUST GAS SYSTEM FOR PREDOMINANTLY STOICHIOMETRICALLY OPERATED INTERNAL COMBUSTION ENGINES, COMPRISING A CATALYST FOR REDUCING AMMONIA EMISSIONS

(71) Applicant: UMICORE AG & CO. KG, Hanau-Wolfgang (DE)

(72) Inventors: Julius KOEGEL, Rodenbach (DE); Massimo COLOMBO, Frankfurt am Main (DE); Sonja BUCHBERGER, Frankfurt (DE); Marcus SCHMIDT, Ginsheim (DE); Niklas OEFNER, Freigericht (DE)

(73) Assignee: UMICORE AG & CO. KG, Hanau-Wolfgang (DE)

(21) Appl. No.: 19/098,820

(22) Filed: Apr. 2, 2025

(30) Foreign Application Priority Data
Apr. 8, 2024 (DE) DE102024109701.9

(51) Int. Cl. B01D 53/94; B01J 37/02; F01N 3/035; F01N 3/10

(52) U.S. Cl. CPC B01D 53/9436; B01D 53/945; B01D 53/9454; B01D 53/9468; B01D 53/9477; B01J 37/0246; F01N 3/035; F01N 3/101; F01N 3/108; B01D 2255/1021; B01D 2255/1023; B01D 2255/1025; B01D 2255/50; B01D 2255/9022; B01D 2255/908; B01D 2255/911; B01D 2258/014; F01N 2250/02; F01N 2370/02

(57) ABSTRACT

The present invention is directed to an exhaust gas system for reducing exhaust gas emissions and in particular ammonia emissions in the exhaust gas train of a predominantly stoichiometrically operated spark ignition engine.

The present invention is directed to an exhaust gas system for reducing exhaust gas emissions and in particular ammonia emissions in the exhaust gas train of a predominantly stoichiometrically operated spark ignition engine.

Exhaust gases from internal combustion engines operated with predominantly (>50% of the operating time) stoichiometric air/fuel mixture, i.e. spark ignition engines or Otto engines powered by gasoline or natural gas, are cleaned in conventional methods with the aid of three-way catalysts (TWC). Such catalysts are capable of simultaneously converting the three major gaseous pollutants of the engine, namely hydrocarbons, carbon monoxide and nitrogen oxides, into harmless components. “Stoichiometric” means that on average exactly as much air is available for combustion of the fuel present in the cylinder as is required for complete combustion. The combustion air ratio (A/F ratio; air/fuel ratio) sets the air mass m_{L,actual} which is actually available for combustion in relation to the stoichiometric air mass m_{L,st}.

$$λ = \frac{{m}_{L , actual}}{{m}_{L , st}}$$

If λ<1 (e.g., 0.9), this means “air deficiency” and one speaks of a rich exhaust gas mixture; >>1 (e.g., 1.1) means “excess air” and the exhaust gas mixture is referred to as lean. The statement A=1.1 means that 10% more air is present than would be required for the stoichiometric reaction. The same applies to exhaust gases from internal combustion engines.

The catalytically active materials used in known three-way catalysts are usually platinum group metals, in particular platinum, palladium and rhodium, which are present, for example, on γ-aluminum oxide as a support material. In addition, three-way catalytic converters contain oxygen-storing materials, e.g., cerium/zirconium mixed oxides. In the latter case, cerium oxide, a rare earth metal oxide, is the component that is fundamental to the oxygen storage. Along with zirconium oxide and cerium oxide, these materials may contain additional components, such as further rare earth metal oxides or alkaline earth metal oxides. Oxygen storage materials are activated by applying catalytically-active materials, such as platinum group metals, and therefore also serve as support material for the platinum group metals.

In the operation of predominantly stoichiometrically operated combustion engines, NH₃ and/or N₂O is produced by a three-way catalyst close to the engine under certain operating conditions. The toxic ammonia and the powerful greenhouse gas N₂O are referred to as secondary emissions, and their emissions cannot be sufficiently reduced by current exhaust gas aftertreatment systems. Compliance with the lowest possible values of these secondary emissions over a wide range of driving situations requires the development of a robust technical solution in the form of a new catalyst for the gasoline exhaust gas train, because in particular the regulation of ammonia emissions from gasoline passenger cars is expected to be the subject of future legislation, such as China 7. The extremely dynamic environmental conditions, especially in the underbody of a gasoline car, represent a major challenge.

Compliance with low emission values for ammonia requires, in particular for low and medium temperature ranges, the use of a storage material to store NH₃ during the rich operating conditions of the internal combustion engine, because the ammonia is formed mainly under these exhaust gas conditions. The conversion of the stored ammonia then takes place during lean operating points by oxidation on a layer containing noble metals and/or as part of an SCR reaction. In this case, the aim is to achieve the lowest possible selectivity to N₂O. A special requirement for the catalysts considered here is the high aging stability of the materials used: In addition to stability under lean gas conditions, their application in the exhaust gas train of stoichiometrically operated internal combustion engines requires them to be stable under hydrothermal exhaust gas conditions, even in exhaust gases with a rich or stoichiometric composition.

Particularly in the diesel sector or for use in lean-burn DI gasoline engines, the use of catalysts that preferentially convert ammonia to nitrogen has already been discussed (U.S. Pat. No. 5,120,695; EP1892395A1; EP1882832A2; EP1876331A2; WO12135871A1; US2011271664AA; WO11110919A1, EP3915679A1). The use of ammonia slip catalysts, or ASC's for short, has also already been described in the field of CNG (compressed natural gas) engines (EP24258A1), These catalysts often consist of an SCR-catalytically active component and an ammonia oxidation catalyzing component. These catalysts are usually located in the underbody at the last point in the exhaust gas system. If there are not enough nitrogen oxides in the system to oxidize the stored ammonia, the ammonia can also be converted into nitrogen with the oxygen present via the ASC.

In DE102023101772A1, it is an object of the present invention to present new exhaust gas systems which allow operation of a predominantly stoichiometrically operated, in particular spark ignition combustion engine in which the smallest possible amounts of harmful exhaust gas components reach the atmosphere. In particular, the correspondingly low values for NH₃ and N₂O, in addition to good conversion of CO, HC, and NOx, should be able to be safely complied with. Moreover, the system should also be correspondingly robust and agile in order to be able to withstand the operating conditions in the exhaust gas train of a corresponding automobile for a sufficient period of time. It should also be as cost-effective to produce as possible.

These and other objects that are obvious from the prior art to a person skilled in the art are achieved by an exhaust gas system and a method for exhaust gas cleaning according to claims 1 and 11. Claims 2-10 relate to preferred embodiments of the exhaust gas system and are accordingly also applicable to the method according to the invention.

By proposing an exhaust gas system for reducing harmful exhaust gas components, comprising a predominantly stoichiometrically operated combustion engine, a first three-way catalyst and, downstream thereof, a catalyst for reducing ammonia emissions which has the following components:
a first component comprising a transition metal exchanged zeolite and/or zeotype for storing ammonia;
a second component comprising an OSC-free noble metal catalyst and/or an OSC-containing noble metal catalyst, wherein the first component has a mixture of medium-pore and large-pore zeolites or zeotypes, and
wherein the second component lies completely over the first and the large- and medium-pore zeolites are deposited in separate layers or as a homogeneous coating on the substrate, the stated object is achieved relatively simply but no less surprisingly. The system according to the invention is characterized by extremely good performance with regard to the reduction of CO, HC, and NOx emissions as well as NH₃ and N₂O emissions. It responds well to the dynamic requirements of the exhaust gas train of a gasoline engine and is correspondingly robust to also meet these requirements for a sufficient period of time. In addition, from a production point of view, it is more advantageous to produce. Moreover, the large-pore zeolites or zeotypes can also serve as hydrocarbon traps and thus help to reduce HC emissions during cold start conditions, for example.

By a coating step familiar to a person skilled in the art (DE102019100099A1 and literature cited therein) the components of the catalyst for reducing ammonia emissions are applied to a support, preferably to a flow-through substrate. A filter substrate such as a wall-flow filter is also possible in this context. Flow-through substrates are catalyst supports commonly used in the prior art, which can consist of metal (for example WO17153239A1, WO16057285A1, WO15121910A1 and literature cited therein) or ceramic materials. “Corrugated substrates” can also be regarded as flow-through substrates. These are known to a person skilled in the art as supports made of corrugated sheets consisting of inert materials. Suitable inert materials are, for example, fibrous materials having an average fiber diameter of 50 to 250 μm and an average fiber length of 2 to 30 mm. Fibrous, heat-resistant materials made of silicon dioxide, in particular glass fibers, are preferred. However, refractory ceramics, such as cordierite, silicon carbide or aluminum titanate, etc., are preferably used as honeycomb supports. The number of channels per surface area is characterized by the cell density, which typically ranges between 300 and 900 cells per square inch (cpsi). The wall thickness of the channel walls in ceramics is between 0.5-0.05 mm.

The total quantity of the coating in the catalyst for reducing the ammonia emissions is selected so that the catalyst according to the invention is used as efficiently as possible overall. In the case of one or more flow-through substrate(s), for example the total quantity of the coating (solids content) per support volume (total volume of the support) may be between 100 and 600 g/L, in particular between 150 and 400 g/L. The first component is preferably used in a quantity of 50 to 350 g/L, in particular between 120 and 250 g/L, particularly preferably of approximately 145-230 g/L support volume. The second component is preferably used from 50 to 350 g/L, in particular between 120 and 250 g/L, particularly preferably from about 145-230 g/L support volume.

According to the invention, the components are present as separate coatings lying one above the other on the substrate. It is preferred if the second component lies completely over the first and completely covers it. This refers to the fact that the first component does not project beyond the second component at any end. It is particularly preferred if the two coatings with their respective components are of equal length (FIG. 2). The length of the layers can be chosen by a person skilled in the art. They are preferably located on a flow-through substrate and here occupy a length of at least 10% and at most 100%, more preferably 30%-100%, extremely preferably 40%-100%, of the substrate length. In this case, a coating that is placed on top of another one comes into contact with the exhaust gas first, before the latter one.

As already indicated above, a first component of the catalyst for reducing ammonia emissions consists of zeolites and/or zeotypes for storing ammonia. In principle, a person skilled in the art is familiar with the zeolites and zeotypes available for this purpose from the diesel sector. In this case, the way zeolites or zeotypes work is based on the fact that they can temporarily store ammonia in operating states of the exhaust gas cleaning system, in which ammonia is produced for example by over-reduction of nitrogen oxides via a three-way catalyst installed upstream, but which cannot be converted by other conventional three-way catalysts, for example due to a lack of oxygen or insufficient operating temperatures. The ammonia stored in this way can then be removed when the operating state of the exhaust gas cleaning system changes and subsequently or directly converted, for example when there is enough oxygen or nitrogen oxide present.

According to the invention, zeolites and zeotypes are present in the first component of the catalyst for reducing the ammonia emissions. According to the classification of the IZA (https://europe.iza-structure.org/IZA-SC/ftc_table.php), the International Zeolite Association, zeolites or zeotypes can be divided into different classes. Zeolites are then classified for example according to their channel system and their framework structure. For example, laumontite and mordenite are classified as zeolites that have a one-dimensional system of channels. Their channels have no connection to one another. Zeolites comprising a two-dimensional channel system are characterized by their channels being connected to one another in a type of layered system. A third group has a three-dimensional framework structure having cross-layer connections between the channels. In the present invention, two and/or three-dimensional zeolites or zeotypes are used [Ch. Baerlocher, W.M. Meier and D.H. Olson, Atlas of Zeolite Framework Types, Elsevier, 2001].

The term “zeolite” refers, according to the invention, to porous materials having a lattice structure of corner-connected AlO4 and SiO4 tetrahedrons according to the general formula (W.M. Meier, Pure & Appl. Chem., vol. 58, no. 10, pp. 1323-1328, 1986):

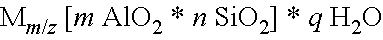

Thus, the structure of a zeolite consists of a grid that is made of tetrahedrons and surrounds channels and cavities. A distinction is made between naturally occurring and synthetically produced zeolites. The term “zeotype” is understood to mean a zeolite-like compound that has the same structural type as a naturally occurring or synthetically produced zeolite compound, but which differs from such compounds in that the corresponding cage structure is not composed exclusively of aluminum and silicon framework atoms. In such compounds, the aluminum and/or silicon structure atoms are replaced by other trivalent, tetravalent or pentavalent structure atoms, such as B(III), Ga(III), Ge(IV), Ti(IV) or P(V). The most common method used in practice is the replacement of aluminum and/or silicon framework atoms by phosphorus atoms, for example in the silicon aluminum phosphates or in the aluminum phosphates, which crystallize in zeolite structure types.

Examples of suitable zeolites come from the group of two-dimensional or three-dimensional zeolites/zeotypes. This structure group comprises, for example, ACO, AEI, AEN, AFN, AFT, AFX, ANA, APC, APD, ATT, BEA, BIK, CDO, CHA, DDR, DFT, EAB, EDI, EPI, ERI, ESV, ETL, FER, GIS, GOO, IHW, ITE, ITW, LEV, KFI, MER, MON, NSI, OWE, PAU, PHI, RHO, RTH, SAT, SAV, SIV, THO, TSC, UEI, UFI, VNI, YUG, ZON.

Zeolites or zeotypes can also be classified according to their pore structure. A distinction is made between small-pore, medium-pore, and large-pore zeolites. Of academic interest are the extra-large-pore zeolites. Small-pore zeolites are those with a largest ring size of 8 tetrahedral units. Medium-pore zeolites have an upper ring size of 10 tetrahedral units. Large-pore zeolites have an upper ring size of 12 tetrahedral units (https://en.wikipedia.org/w/index.php?title=Zeolite&oldid=1103217432 and literature cited there). Possible medium-pore zeolites or zeotypes for storing ammonia are AEL, AFO, AHT, BOF, BOZ, CGF, CGS, CSV, DAC, EOS, ETV, EUO, EWO, EWS, FER, HEU, IFW, IMF, -ION, ITH, ITR, JRY, JST, LAU, -LIT, MEL, MFI, MFS, MTT, MVY, MWW, NES, OBW, -PAR, PCR, PON, PSI, PTF, PTY, PWW, RFE, RRO, SFF, SFG, STF, STI, STW, -SVR, TER, TON, TUN, UOS, WEI and -WEN. In this context, FER, MFI and MTT are preferred, with FER being extremely preferred. Large-pore zeolites or zeotypes for storing ammonia are preferably selected from the group consisting of BEA, FAU, or MOR. BEA is particularly preferred in this context.

The aging stability of the zeolites or zeotypes used in the exhaust gas train of predominantly stoichiometrically combusting engines is particularly in focus here, since higher temperatures generally prevail here than in a lean-burn engine. In this respect, those materials are desired which can withstand for as long as possible the sometimes very high and strongly changing hydrothermal conditions. In addition, the exhaust gas composition is also different compared to lean-burn engine exhaust gas. The concentration of hydrocarbons and carbon monoxide in particular, which reach the catalyst according to the invention, is higher than in lean-burn engines, and the composition also changes around the stoichiometric range depending on the driving style (rich/lean change). The hydrothermal temperature stability of zeolites and zeotypes as well as the stability with respect to rich and stoichiometric gas compositions is therefore particularly sought after. Preferably, the medium-pore zeolites used have a SAR value (silica-to-alumina ratio) or the zeotypes have a ratio corresponding to this value of >10 to <50, very preferably from >15 to <35. A range of 15-25 is highly preferred in this context. Preferably, the large-pore zeolites used have a SAR value (silica-to-alumina ratio) or the zeotype has a ratio corresponding to this value of >10 to <50, very preferably from >10 to <40. A range of 15-30 is highly preferred in this context. To calculate the SAR value for zeolites, the quantity of silicon atoms remaining in the framework is compared to the number of substitution atoms. This gives rise to the number of negative charges in the base body and thus to a measure for the number of counterions that must be absorbed until electroneutrality is achieved. A corresponding ratio can be determined for zeotypes.

According to the invention, the zeolite or zeotype used is ion-exchanged with transition metal ions. The latter are preferably selected from the group consisting of iron and/or copper. Iron is particularly preferred because, in comparison to copper, it has less oxidizing effect on ammonia. These compounds have the ability to comproportionate nitrogen oxides present in the exhaust gas, and the stored ammonia in lean conditions, to form nitrogen. In this case, the described zeolite or zeotype acts as a catalyst for selective catalytic reduction (SCR) (see WO2008106518A2, WO2017187344A1, US2015290632AA, US2015231617AA, WO2014062949A1, US2015231617AA). In this case, SCR capability is understood to mean the ability to selectively convert NOx and NH₃ in the lean exhaust gas into nitrogen.

The metals which are advantageously present in the catalyst for reducing the ammonia emissions, such as iron and/or copper, are present in the first component in a certain proportion. This is 0.4-10, more preferably 0.8-7, and very preferably 1.5-5.0 wt. % of the first component. The iron and/or copper to aluminum ratio is between 0.05-0.8, preferably between 0.2 -0.5, and most preferably between 0.3-0.5 for zeolites. For the zeotype, a corresponding ratio applies to the exchange sites available there. In this case, the metals are present at least in part in ion-exchanged form in the zeolites or zeotypes. Preferably, ion-exchanged zeolites or zeotypes are already introduced into the first component. However, it is also possible that the zeolites or zeotypes are brought together with, for example, a binder and a solution of the metal ions in a liquid, preferably water, and then dried (preferably by spray-drying). Here, certain amounts of the metals can also be found on the binder in the form of oxides. Both approaches are possible.

However, ion exchange is a challenge for medium-pore zeolites. While ion exchange for large-pore zeolites can be performed as part of the washcoat process, since the ions readily penetrate into the large zeolite pores and occupy the ion exchange positions of the material, the coating of medium-pore zeolites requires a separate process step. This can be an incipient wetness process or an ion exchange process with, optionally, subsequent spray drying. The processes for producing metal-exchanged zeolites and zeotypes are well known to a person skilled in the art. However, an approach which is preferred from a production perspective is to coat the substrate with a mixture of a medium-pore zeolite, a large-pore zeolite and a soluble salt of the ions to be exchanged (e.g., Fe(NO₃)₃×9 H₂O, Cu nitrate) with, optionally, a common binder system. The dissolved ions are initially absorbed by the large-pore zeolite. A distribution of the ions between large-pore and medium-pore zeolite then occurs during the calcination process. In addition to saving a process step, it is expected that a catalyst obtained in this way will benefit from the high stability of the ammonia storage function of the medium-pore zeolite as well as from the typically high SCR activity of the large-pore exchanged zeolite and will thus show good performance and selectivity in the described application. Another well-known property of ion-exchanged large-pore zeolites is their ability to store hydrocarbons, which gives the formulated ammonia storage the properties of a so-called hydrocarbon trap. During cold start, incoming hydrocarbons can be captured and can then desorb at higher temperatures and be converted via the existing three-way catalysts or oxidation catalysts, which are then active.

The first component contains large-pore and medium-pore zeolites. These can be deposited in separate layers on the substrate. The order of the layers of large-pore and medium-pore zeolites and the corresponding loading amounts can be varied. In addition, it is possible to mix the different types of zeolite and apply them to the support as a homogeneous coating. The ratio of the different zeolite types to each other can be varied. The zeolites can be used in a form that is free of transition metals as well as coated with transition metals, preferably iron or copper. The large-pore and medium-pore zeolites are preferably used in a weight ratio of 5:1 to 1:5, more preferably 2:1 to 1:2. A balance between the ability to store HC and the ammonia storage capacity can be specifically adjusted and adapted to the application in question by the ratio of large-pore and medium-pore zeolites or zeotypes in the mixture or layers.

In addition to the zeolites or zeotypes, the first component may preferably contain non-catalytically active components, such as binders, For example, active temperature-stable metal oxides with little or no catalytic activity, such as SiO₂, Al₂O₃ and ZrO₂, are suitable as binders. A person skilled in the art is aware of the materials that can be used here. The proportion of such binders in the first coating can, for example, amount to up to 15 wt. %, preferably up to 10 wt. %, of the component. The binder may also contain the transition metals listed above, in particular iron and/or copper. Binders are suitable for ensuring stronger adhesion of the coating to a support or to a further coating. For this purpose, a certain particle size of the metal oxides in the binder is advantageous. This can be adjusted accordingly by a person skilled in the art.

The ammonia storage capacity discussed in the context of this invention is specified as a quotient of stored ammonia mass per liter of catalyst support volume. The first component should increase the ammonia storage capacity of the exhaust gas cleaning system to at least 0.25 g ammonia per L support volume (measured in the fresh state). Overall, the storage capacity of the ammonia storage components used in the form of the zeolites or zeotypes should be sufficient to allow between 0.25 and 10.0 g of NH₃ per liter of support volume, preferably between 0.5 and 8.0 g NH₃ per liter of support volume, and particularly preferably between 0.5 and 5.0 g of NH₃ per liter of support volume of ammonia, to be stored in the system (always with respect to the fresh state). The zeolites or zeotypes are present in a sufficient quantity in the catalyst to reduce ammonia emissions. The determination of the ammonia storage capacity is shown further below.

The second component consists of an OSC-free noble metal catalyst and/or an OSC-containing noble metal catalyst. Noble metals include in particular the platinum group metals platinum, palladium and rhodium. Accordingly, the noble metals in the OSC-free or OSC-containing noble metal catalyst are preferably selected from the group consisting of palladium, platinum and rhodium. OSC stands for oxygen storage component. A noble metal catalyst containing OSC therefore contains oxygen storage materials.

By contrast, the OSC-free noble metal catalyst essentially does not have any function of storing the oxygen in the exhaust gas of the internal combustion engine. In particular, this component has oxygen storage materials, in particular cerium-zirconium mixed oxides, in an amount of less than 10 g/L, preferably less than 5 g/L, and most preferably less than 2 g/L support volume. The entire amount of cerium or cerium-zirconium mixed oxides, for example, including the doping elements present, is considered storage material. The oxygen storage capacity is determined at a temperature of 510° C.

Corresponding OSC-free noble metal catalysts have the ability to have an oxidative effect on the substances present (NH₃, HC, CO) in the already slightly lean exhaust gas of a predominantly stoichiometrically operated internal combustion engine. In this case, this component is preferably designed in such a way that it becomes active at correspondingly low temperatures. The ammonia stored in the zeolite or zeotype is preferentially converted here into non-harmful nitrogen via this component. The oxidation effect should not be too great, otherwise a certain quantity of the powerful greenhouse gas N₂O will be formed from the ammonia oxidation. The oxidizing power can, inter alia, be adjusted by the amount of platinum and the Pt: Pd and/or Pt: Rh ratio.

The second component in the form of an OSC-free noble metal catalyst therefore contains materials that have an oxidative effect on, inter alia, ammonia. Normally, this component contains a temperature-stable, large-surface-area metal oxide and at least one noble metal selected from the group of rhodium, platinum, and palladium. The total noble metal content of this component is preferably from 0.015-5 g/L, more preferably from 0.035-1.8 g/L, and particularly preferably from 0.07-1.2 g/L support volume. The noble metals platinum or palladium, or platinum and palladium together, are particularly suitable for use in this component that has an oxidative effect on ammonia. The person skilled in the art can preferably choose whether to use the strongly oxidative platinum alone or, optionally, in combination with palladium in the second coating layer. If platinum and/or palladium is used, the former should be in the range of 0.015-1.42 g/L, more preferably 0.035-0.35 g/L support volume, in the coating. When present in the coating, palladium can be present at between 0.015-1.42 g/L, preferably 0.035-0.35 g/L support volume. The weight ratio of platinum to palladium should be between 1:0 and 1:5, more preferably 1:0 and 1:4, and most preferably 1:0 and 1:2.

The noble metals in the OSC-free second component are, as mentioned, typically fixed to one or more temperature-stable, large-surface-area metal oxides as support materials. All materials that are familiar to the person skilled in the art for this purpose are considered as support materials. Such materials are in particular metal oxides with a BET surface area of 30 to 250 m²/g, preferably 100 to 200 m²/g (determined according to DIN 66132, latest version as of filing date). Particularly suitable support materials for the noble metals are selected from the series consisting of alumina, doped alumina, silicon oxide, titanium dioxide, and mixed oxides of one or more thereof. Doped aluminum oxides are, for example, aluminum oxides doped with lanthanum oxide, zirconium oxide, barium oxide and/or titanium oxide. Aluminum oxide or lanthanum-stabilized aluminum oxide is advantageously used, wherein lanthanum is used in quantities of 1 to 10% by weight, preferably 3 to 6% by weight, in each case calculated as La₂O₃ and based on the weight of the stabilized aluminum oxide. Also in the case of aluminum oxide doped with barium oxide, the proportion of barium oxide is in particular 1 to 10% by weight, preferably 3 to 6% by weight, in each case calculated as BaO and based on the weight of the stabilized aluminum oxide. Another suitable support material is lanthanum-stabilized aluminum oxide, the surface of which is coated with lanthanum oxide, with barium oxide, and/or with strontium oxide. This component preferably comprises at least one aluminum oxide or doped aluminum oxide. La-stabilized γ-aluminum oxide having a surface area of 100 to 200 m²/g is particularly advantageous in this context. Active aluminum oxide of this kind is frequently described in the literature and is commercially available.

The catalyst for reducing ammonia emissions has an OSC-free noble metal catalyst as an alternative or in addition to the OSC-free noble metal catalyst.

In addition to the noble metals and the temperature-stable, large-surface-area metal oxides mentioned above, oxygen storage materials are also present in the noble metal catalyst (containing OSC). Cerium-or cerium-zirconium mixed oxides (see below) are consistently used as oxygen storage materials. Accordingly, an OSC-containing noble metal catalyst is characterized by the presence of a certain quantity of these oxygen storage materials. In particular, this component has oxygen storage materials in an amount of more than 10 g/L, preferably more than 20 g/L, and most preferably more than 25 g/L support volume. In this case, the entire cerium-zirconium mixed oxide with all its components is included.

Corresponding OSC-containing noble metal catalysts have the ability to have an oxidative effect on the substances present (NH₃, HC, CO) in the already slightly rich exhaust gas of a predominantly stoichiometrically operated internal combustion engine. In this case, this component is preferably designed in such a way that it becomes active at correspondingly low temperatures. The ammonia stored in the zeolite or zeotype is preferentially converted here into non-harmful nitrogen via this component. The oxidation effect should not be too great, otherwise a certain quantity of the powerful greenhouse gas N₂O will be formed from the ammonia oxidation.

The noble metals in the OSC-containing noble metal catalyst are preferably selected from the group consisting of palladium or rhodium or platinum, platinum and rhodium, palladium and rhodium or palladium and rhodium and platinum together. Preferably, this catalyst is a coating equipped with three-way catalytic capability. This particularly preferably has noble metals selected from the group platinum and rhodium, palladium and rhodium, preferably rhodium alone. In the OSC-containing noble metal catalyst, the noble metals can only be present deposited on the temperature-stable, large-surface-area support materials. However, it is preferred if the noble metals are deposited on both said support materials and on the oxygen storage materials.

If rhodium is present in this component (whether alone or in combination with the other previously mentioned noble metals), it should preferably be in the range of 0.015-1.0 g/L, more preferably 0.1-0.35 g/L support volume in the relevant component. If palladium and/or platinum are also present in this component, the ranges stated above for the OSC-free noble metal catalysts apply to these metals. Suitable three-way catalytically active coatings are described, for example, in DE102013210270A1, DE102020101876A1, EP3247493A1, EP3727655A1.

Modern Otto engines are operated under conditions with a discontinuous course of the air ratio). They undergo a periodic change in the air ratio λ in a defined manner, and thus a periodic change in oxidizing and reducing exhaust gas conditions. This change in the air ratio λ is in both cases significant for the exhaust gas purification result. To this end, the λ value of the exhaust gas is regulated with a very short cycle time (ca. 0.5 to 5 hertz) and an amplitude Δλ of 0.005≤Δλ≤0.05 at the value λ=1 (reducing and oxidizing exhaust gas components are present in a stoichiometric relationship to each other). Due to the dynamic mode of engine operation in the vehicle, deviations from this state also occur. In order for the mentioned deviations to not have a negative effect on the exhaust gas cleaning results when the exhaust gas flows over the three-way catalyst, the oxygen storage materials contained in the catalyst balance out these deviations to a certain degree by absorbing oxygen from the exhaust gas or releasing it into the exhaust gas, as needed (Catalytic Air Pollution Control, Commercial Technology, R. Heck et al., 1995, p. 90).

The OSC-containing noble metal catalysts (as in modern three-way catalysts) therefore contain oxygen storage materials, in particular cerium or Ce/Zr mixed oxides. The mass ratio of cerium oxide to zirconium oxide in these mixed oxides can vary within wide limits. It is, for example, 0.1 to 1.5, preferably 0.15 to 1 or 0.2 to 0.9. Preferred cerium/zirconium mixed oxides comprise one or more rare earth metal oxides and can thus be referred to as cerium/zirconium/rare earth metal mixed oxides. The term “cerium/zirconium/rare earth metal mixed oxide” within the meaning of the present invention excludes physical mixtures of cerium oxide, zirconium oxide, and rare earth oxide. It is rather the case that “cerium/zirconium/rare earth metal mixed oxides” are characterized by a largely homogeneous, three-dimensional crystal structure that is ideally free of phases of pure cerium oxide, zirconium oxide or rare earth oxide (referred to as fixed solution). Depending on the manufacturing process, however, not completely homogeneous products may arise which can generally be used without any disadvantage. The same applies to cerium/zirconium mixed oxides which do not contain any rare earth metal oxide. In all other respects, the term “rare earth metal” or “rare earth metal oxide” within the meaning of the present invention does not include cerium or cerium oxide. Lanthanum oxide, yttrium oxide, praseodymium oxide, neodymium oxide and/or samarium oxide can, for example, be considered as rare earth metal oxides in the cerium-zirconium-rare earth metal mixed oxides. Lanthanum oxide, yttrium oxide and/or praseodymium oxide are preferred. Particularly preferred rare earth metal oxides are lanthanum oxide and/or yttrium oxide, and very particularly preferred is the joint presence of lanthanum oxide and yttrium oxide, yttrium oxide and praseodymium oxide, as well as lanthanum oxide and praseodymium oxide in the cerium/zirconium/rare earth metal mixed oxide. In a preferred embodiment, this noble metal catalyst comprises two different cerium/zirconium/rare earth metal mixed oxides, preferably one doped with La and Y and one doped with La and Pr. In embodiments of the present invention, the oxygen storage components are preferably free from neodymium oxide.

The proportion of rare earth metal oxide(s) in the cerium/zirconium/rare earth metal mixed oxides is advantageously 3 to 20 wt. % based on the cerium/zirconium/rare earth metal mixed oxide. If the cerium/zirconium/rare earth metal mixed oxides contain yttrium oxide as a rare earth metal, the proportion thereof is preferably 4 to 15% by weight based on the cerium/zirconium/rare earth metal mixed oxide. If the cerium/zirconium/rare earth metal mixed oxides contain praseodymium oxide as a rare earth metal, the proportion thereof is preferably 2 to 10 wt. % based on the cerium/zirconium/rare earth metal mixed oxide. If the cerium/zirconium/rare earth metal mixed oxides contain lanthanum oxide and a further rare earth oxide as a rare earth metal, such as yttrium oxide or praseodymium oxide, the mass ratio thereof is in particular 0.1 to 1.25, preferably 0.1 to 1. Typically, this noble metal catalyst contains oxygen storage materials in amounts of 15 to 120 g/l, based on the volume of the support or substrate.

The OSC-containing noble metal catalysts also have the temperature-stable, large-surface-area support materials mentioned for the OSC-free noble metal catalysts and, in addition to these, oxygen-storing materials. The mass ratio of temperature-stable, large-surface-area support materials and oxygen storage components in this component is usually 0.25 to 1.5—for example, 0.3 to 1.3. In an exemplary embodiment, the weight ratio of the sum of the masses of all support materials, e.g., aluminum oxides (including doped aluminum oxides), to the sum of the masses of all cerium/zirconium mixed oxides in the OSC-containing noble metal catalyst is 10:90 to 75:25, preferably 20:80 to 65:35.

The first and the second components preferably form an ammonia store and a function for the oxidation of ammonia to nitrogen (e.g., as in WO2008106523A2). If there are not enough nitrogen oxides present in the system to oxidize the stored ammonia, the ammonia can also be converted into nitrogen, with the oxygen present. In both cases, as little ammonia or N₂O as possible is released into the environment. In the broadest sense, the first component and the second component of the catalyst for reducing ammonia emissions can thus preferably consist of an ammonia-storing coating paired with a second coating that has an oxidative effect on ammonia. As such, according to the invention they are present in separate coatings one above the other on the substrate. It is particularly preferred if the two coatings are the same length. It is particularly preferred if, for further improved three-way activity, the OSC-containing noble metal catalyst of component two is located as an upper layer above the first component made of zeolites and/or zeotypes for storing ammonia as a lower layer. Most preferably, no further layers are present on the substrate below or above these two coatings.

In a further preferred embodiment, it has proven advantageous if a thin, further separate layer of inert, temperature-stable, large-surface-area metal oxides is present between the two layers/components just mentioned. A person skilled in the art will use the coating methods mentioned above to produce them. This thin layer, between 5 μm and 200 μm, preferably between 10 μm and 150 μm, high helps to further increase the aging stability of the catalyst for reducing ammonia emissions. As it turns out, a disadvantage of the known systems for reducing ammonia emissions may be that the transition metals in the first component, such as iron and/or copper, tend to diffuse into the ammonia oxidation component and poison it after a long period of use in the exhaust gas train of a predominantly stoichiometrically operated internal combustion engine. The result is a lower activity of the ammonia-storing components and also of the oxidative components. In particular those materials selected from the group consisting of aluminum oxide, silicon oxide, titanium oxide, zirconium oxide, zeolites or mixtures thereof are possible as materials of this layer. In this context, a layer of aluminum oxide or silicon oxide is very particularly preferred, which is preferably located on the substrate over the same length above the lower layer and below the upper layer. The intermediate layer is preferably free of additional noble metals.

The present exhaust gas system has a first three-way catalyst and a downstream catalyst for reducing ammonia emissions. In this case, the first three-way catalyst can have the same components as the OSC-containing noble metal catalyst of the second component. Preferably, it is structured as described in DE102013210270A1, DE102020101876A1, EP3247493A1, EP3727655A1, preferably as in EP3247493A1 or EP4096811A1. Downstream refers to the fact that the exhaust gas flow first hits the upstream catalyst and only then the one positioned downstream. The opposite applies on the upstream side.

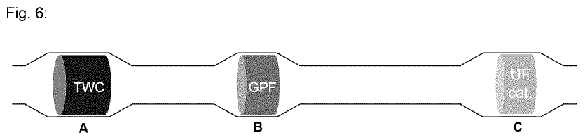

With regard to the objective of the present invention, it has proven advantageous if an exhaust gas system for a predominantly stoichiometrically combusting engine has a unit for filtering small soot and ash particles. Accordingly, an exhaust gas system is preferred which additionally has an optionally catalytically coated GPF between the first three-way catalyst and the catalyst for reducing ammonia emissions (FIG. 6). GPFs are gasoline particle filters and are well-known to a person skilled in the art (EP3737491A1, EP3601755A1). Particularly preferred is an exhaust gas design in which the first three-way catalyst and the GPF are installed in a position close to the engine.

Close to the engine in the sense of the invention refers to a region in the exhaust gas system that is located close to the engine, i.e. approximately 10-80 cm, preferably 20-60 cm, from the engine outlet. It has been found to be advantageous if the catalyst for reducing ammonia emissions is installed last in the exhaust gas direction, in the underbody of a vehicle, so that the exhaust gas is then released into the ambient air. The exhaust gas system may also contain additional exhaust gas units, such as additional three-way catalysts or hydrocarbon storage units (HC traps) or nitrogen oxide storage units (LNT). The underbody is the region beneath the driver's cab.

In a further preferred embodiment, at least one second three-way catalyst (TWC) is located between the first three-way catalyst and upstream of the catalyst for reducing ammonia emissions in the automobile exhaust gas system according to the invention. The three-way activity has already been described earlier. Explicit reference is made to this, in particular with regard to the type and quantity of the individual components. This three-way catalyst is preferably one as described in the prior art (DE102013210270A1, DE102020101876A1, EP3247493A1, EP3727655A1, EP4096811A1). Zoned or layered embodiments are now the norm for TWCs. In a further preferred embodiment, in the automobile exhaust gas system according to the invention at least one of the additional catalysts having three-way activity has a 2-layer structure comprising two different three-way coatings, preferably as described in EP3247493A1 or EP4096811A1. The at least second three-way catalyst, described above, in the exhaust gas system according to the invention can be installed in the underbody of the vehicle, but it can also be located in a position close to the engine. The range of possible exhaust gas systems is large. For example, preferably up to four three-way catalysts can be installed per exhaust gas train, upstream of the catalyst for reducing ammonia emissions. It is also conceivable that the described catalyst for reducing ammonia emissions is installed directly downstream of the three-way catalyst in a position close to the engine and that other components for reducing emissions, such as a particulate filter, are installed downstream thereof. Therefore, the present invention preferably relates to a system which, viewed in the flow direction of the exhaust gas, has a first TWC (1) close to the engine followed by the described catalyst for reducing ammonia emissions, also in a position close to the engine, and downstream thereof a particulate filter in the underbody of the vehicle, optionally followed by a further TWC (2).

In an alternative embodiment, at least one three-way catalyst and an optionally catalytically coated wall-flow filter (GPF) are located upstream of the catalyst for reducing ammonia emissions. In this case, the catalyst for reducing ammonia emissions is preferably located at a last point in the underbody and in fluidic communication with the other catalyst(s) or the filter of the automobile exhaust gas system. Preferably, in this case, the vehicle exhaust gas system does not have an additional injection device for ammonia or a precursor compound for ammonia. However, it is possible that a supply unit for secondary air is located in the exhaust gas train upstream of the catalyst for reducing ammonia emissions or upstream of the wall-flow filter (analogously to WO2019219816A1).

In a further aspect, the present invention relates to a method for reducing harmful exhaust gas components from predominantly stoichiometrically operated internal combustion engines, in particular spark ignition gasoline engines, in which the exhaust gas is passed through an exhaust gas system according to the invention. It should be noted that the preferred embodiments of the automobile exhaust gas system also apply mutatis mutandis to the present method.

The present invention is directed to an exhaust gas cleaning system, in particular for stoichiometrically operated internal combustion engines. There are operating points of a stoichiometrically burning engine in which a rich exhaust gas is produced within a certain temperature interval. This can lead to nitrogen oxides arriving via a three-way catalyst being over-reduced to ammonia. This ammonia should not be released into the environment. The ammonia is therefore stored via the catalyst for reducing ammonia emissions, and is then oxidized to nitrogen under slightly oxidizing conditions. Here, too, care must be taken to ensure that as far as possible no over-oxidation to N₂O occurs. The ammonia storage catalyst is also easy to produce, since possibly only a simplified ion exchange step is necessary in the production of the first component or the iron can be introduced entirely by means of the washcoat process. Nevertheless, even after intensive aging, the system is robust enough to fully meet the requirements.

The figures show:

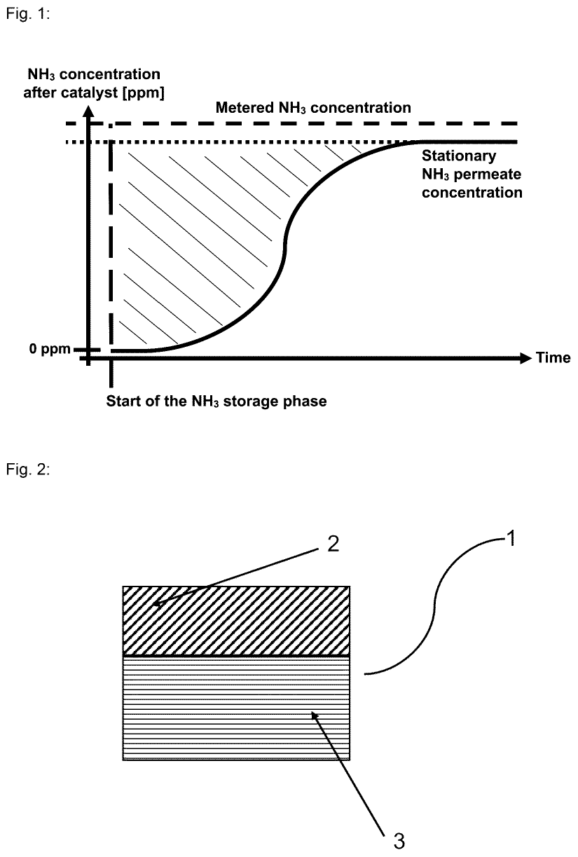

FIG. 1: Chart explaining the measurement of ammonia storage capacity.

FIG. 2: Catalyst for reducing ammonia emissions (1), coating with metal-free zeolites or zeotypes for storing ammonia (2) and a coating with an OSC-free noble metal catalyst and/or an OSC-containing noble metal catalyst (3).

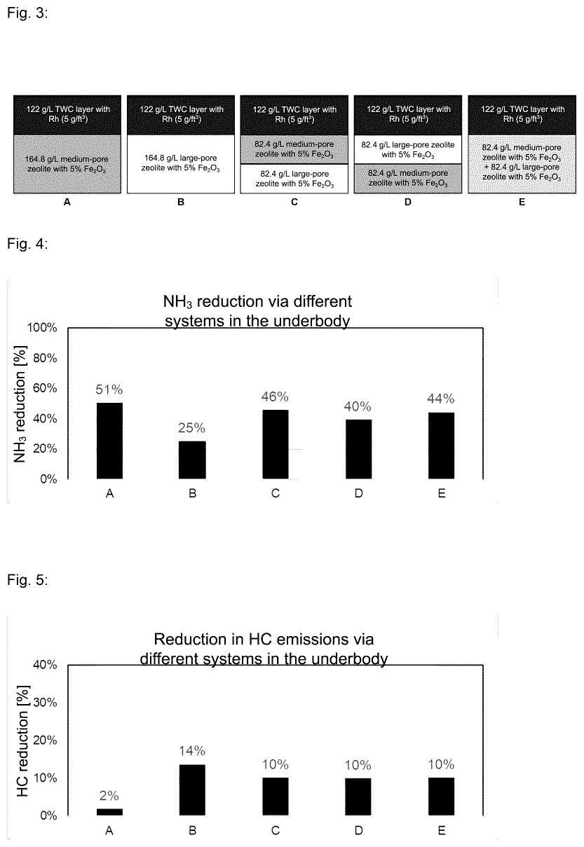

FIG. 3: Schematic representation of the catalysts tested in an underbody position.

FIG. 4: Reduction of ammonia emissions by catalysts A to E compared to a system without an underbody catalyst.

FIG. 5: Reduction of hydrocarbon emissions by catalysts A to E compared to a system without an underbody catalyst.

FIG. 6: Exhaust system according to the invention with close-coupled three-way catalyst (A), close-coupled GPF (B), and downstream catalyst for reducing ammonia emissions (C).

### EXAMPLES

### A. Determination of Ammonia Storage Capacity

It is determined experimentally in a flow tube reactor. In order to avoid undesirable ammonia oxidation on the reactor material, a reactor made of quartz glass is used. From the region of the catalyst whose ammonia storage capacity is to be determined, a drill core is taken as specimen. Preferably, a drill core 1 inch in diameter and 3 inches long is taken as the specimen. The drill core is inserted into the flow tube reactor and conditioned at a temperature of 600° C. in a gas atmosphere of 500 ppm nitrogen monoxide, 5 vol. % oxygen, 5 vol. % water, and remainder of nitrogen at a space velocity of 30,000 h⁻¹ for 10 minutes. Subsequently, in a gas mixture of 0 vol. % oxygen, 5 vol. % water, and remainder nitrogen at a space velocity of 30 000 h⁻¹, the measuring temperature of 200° C. is approached. After stabilization of the temperature, the NH₃ storage phase is initiated by switching on a gas mixture of 450 ppm ammonia, 0 vol. % oxygen, 5 vol. % water, and remainder nitrogen at a space velocity of 30,000 h⁻¹. This gas mixture is added until a stationary ammonia permeate concentration is registered downstream of the specimen. The mass of ammonia stored on the specimen is calculated from the recorded ammonia breakthrough curve by integrating from the start of the NH₃ storage phase until stationarity is reached, taking into account the measured steady-state NH₃ breakthrough concentration and the known volume flow (hatched area in FIG. 1). The ammonia storage capacity is calculated as quotient of the stored ammonia mass divided by the volume of the tested drill core.

### B. Production of the Zeolite-Containing Layers

### B1. Production of the Coating on Basis of a Large-Pore Zeolite

The iron-containing zeolite coating was produced using a washcoat consisting of a large-pore zeolite of the BEA structure type, iron (III) nitrate solution, and an appropriate amount of a binder system consisting of an Al₂O₃ and a SiO₂ component. The coating with the desired washcoat amount was carried out in one step over 100% of the substrate length. The coated catalyst thus obtained was dried at 90° C. and then calcined at 350° C. for 15 min and annealed at 550° C. in air for 2 h. If necessary, further layers can be applied as a top layer to the now coated support.

### B2. Production of the Coating on Basis of a Small-Pore Zeolite

Coating with white (=transition-metal-free) zeolite of the chabazite type was performed after co-grinding of the zeolite material suspended in water with Nyacol® AL20 binder on a cordierite substrate with the desired washcoat loading (88% zeolite, 12% binder). The coated catalyst thus obtained was dried at 90° C., calcined at 350° C. for 15 min, and then annealed at 600° C. in air for 2 h. If necessary, further layers can be applied as a top layer to the now coated support.

### B3. Production of the Coating on Basis of a Mixture of Large-Pore and Medium-Pore Zeolites

A washcoat for the coating application of the zeolite-containing layer is produced by combining a medium-pore zeolite of the FER structure type having a SiO₂/Al₂O₃ ratio of 18, a large-pore BEA zeolite and a soluble iron salt (e.g., Fe(NO₃)₃×9 H₂O) with a suitable binder system (e.g., Aeroperl/Pural or Nyacol AL20), linearly ground, and stirred for 24 h at room temperature, before the coating application to a support is carried out. The layer is dried at 90° C., and then the support is calcined for 15 min at 350° C. and annealed in air for 2 h at 600° C. If necessary, further layers can be applied as a top layer to the now coated support.

The medium-pore zeolite and the large-pore zeolite can be applied either homogeneously in one layer or in two separate layers, as shown in FIG. 3. In the case of a homogeneous layer, the medium-pore zeolite can be used in its already iron-exchanged form or the complete amount of iron can be introduced during the washcoat process by means of an iron salt.

C. Preparation of the Platinum-Containing SiO₂/Al₂O₃ Layer without TWC Activity

A silicon-aluminum mixed oxide consisting of 95 wt. % aluminum oxide and 5 wt. % silicon oxide was suspended in water. The suspension thus obtained was adjusted to pH 7.6+0.4 and then treated with EA platinum solution under constant stirring. The resulting suspension was ground and, after stabilization with ammonium acetate, used to coat a commercially available support, the coating being applied over 100% of the support length. The total loading of this washcoat on the catalyst was 25 g/L; the noble metal loading was 0.106 g/L (3 g/ft³). The coated catalytic converter thus obtained was dried and then calcined and tempered.

D. Production of Noble-Metal-Containing Coatings with TWC Activity

Aluminum oxide stabilized with lanthanum oxide was suspended in water together with an oxygen storage component containing 26.5 wt. % cerium oxide, 57 wt. % zirconium oxide, 4 wt. % lanthanum oxide and 12.5 wt. % yttrium oxide. The weight ratio of aluminum oxide to oxygen storage components to additional lanthanum oxide was 43.6:55.7:0.7. The suspension thus obtained was subsequently mixed with a rhodium nitrate solution under constant stirring. The resulting coating suspension was used directly for coating a commercially available substrate, the coating being applied over 100% of the substrate length. The total loading of this washcoat on the catalyst can, for example, be 122 g/L; the noble metal loading 0.177 g/L (5 g/ft³). The coated catalytic converter thus obtained was dried and then calcined and tempered.

Catalysts were prepared as shown schematically in FIG. 3.

### E. Aging and Testing of ASCs

### Aging Conditions:

In order to determine the catalytic properties of the catalysts according to the invention, these were first aged in an engine test bench downstream of a TWC close to the engine in the underbody position (“fuel-cut aging”). The aging process consists of an overrun cut-off aging process at an exhaust gas temperature of 950° C. before the input of the TWC close to the engine (maximum bed temperature of 1030° C.). The aging time and the inlet temperature for the catalyst in underbody position are specified individually for each test.

### Test Conditions:

The different catalysts were tested in the underbody position on a highly dynamic engine test bench in a WLTC driving cycle. Here, a series-produced Pd/Rh-containing TWC in an aged state was placed in a position close to the engine. The “reduction in NH₃ emissions” value refers in each case to the NH₃ emissions of a system with one of the catalysts shown in the underbody position over the entire driving cycle in relation to the emissions of the corresponding system in the absence of a catalyst in the underbody position.

### F. Results

Comparison of catalysts with zeolite-containing lower layers consisting of different combinations of medium- and large-pore zeolites and a Rh-containing TWC top layer: See FIGS. 4 and 5.

All catalysts with TWC layer contain 5 g/ft³ Rh. Aging: Fuel-cut aging, 19 h, 860° C. bed temperature for the catalysts in the underbody position Underbody catalyst volume: 0.83 |

Catalysts in which a mixture of a medium- and a large-pore zeolite with a TWC layer having 5 g/ft³ Rh, the zeolites being present in separate layers (C+D) or in a homogeneous mixture (E), exhibit three-way catalytic activity and are also able to lower the NH₃ emissions and to reduce HC emissions during cold starts by storing hydrocarbons. Compared to corresponding reference catalysts which contain only a medium-pore zeolite (A) or only a large-pore zeolite (B), the NH₃ emissions and HC emissions are reduced by the catalysts C-E to a greater extent than would be expected for a mixture of the zeolites based on a linear extrapolation of the properties.

1. An exhaust gas system for reducing harmful exhaust gas components, comprising a predominantly stoichiometrically operated combustion engine, a first three-way catalyst and, downstream thereof, a catalyst for reducing ammonia emissions which has the following components:
a first component having a transition-metal-exchanged zeolite and/or zeotype for storing ammonia;
a second component comprising an OSC-free noble metal catalyst and/or an OSC-containing noble metal catalyst, wherein
the first component has a mixture of medium-pore and large-pore zeolites or zeotypes, characterized in that
the second component lies completely over the first, and the large-pore and medium-pore zeolites are deposited in separate layers or as a homogeneous coating on the substrate.

2. The exhaust gas system according to claim 1, characterized in that the medium-pore zeolites or zeotypes for storing ammonia are selected from the group consisting of FER, MFI, or MTT.

3. The exhaust gas system according to claim 1, characterized in that the large-pore zeolites or zeotypes for storing ammonia are selected from the group consisting of BEA, FAU, or MOR.

4. The exhaust gas system according to claim 1, characterized in that iron and/or copper are present as transition metals.

5. The exhaust gas system according to claim 1, characterized in that the first component has, in the fresh state, an ammonia storage capacity of between 0.25 and 10.0 g NH₃ per liter of support volume.

6. The exhaust gas system according to claim 1, characterized in that the noble metals in the OSC-free or OSC-containing noble metal catalyst are selected from the group consisting of palladium, platinum and rhodium.

7. The exhaust gas system according to claim 1, characterized in that in the case of the presence of OSC-containing noble metal catalysts, the noble metals are deposited both on temperature-stable, large-surface-area support materials and on the oxygen storage materials.

8. The exhaust gas system according to claim 1, characterized in that it additionally has a GPF between the first three-way catalyst and the catalyst for reducing ammonia emissions.

9. The exhaust gas system according to claim 1, characterized in that the first three-way catalyst and the GPF are installed close to the engine.

10. The exhaust gas system according to claim 1, characterized in that the catalyst for reducing ammonia emissions is installed at a last point in the exhaust gas direction, in the underbody of a vehicle.

11. The exhaust gas system according to claim 1, characterized in that viewed in the flow direction of the exhaust gas, a first three-way catalyst close to the engine, followed by the catalyst for reducing ammonia emissions, also in a position close to the engine, and downstream thereof a particulate filter in the underbody of the vehicle, optionally followed by a further three-way catalyst.

12. A method for reducing harmful exhaust gas components from predominantly stoichiometrically operated internal combustion engines, in particular spark ignition gasoline engines, characterized in that the exhaust gas is passed through an exhaust gas system according to claim 1.
